(19) United States
(12) Patent Application Publication
(10) Pub. No.: US 2025/0371537 A1
(43) Pub. Date: Dec. 4, 2025

(54) TRUSTED SIGNING SERVICE AND SPONSORED PAYMASTER FOR TRANSACTION FEES IN NATIVE CRYPTOCURRENCY

(71) Applicant: Circle Internet Group, Inc., New York, NY (US)

(72) Inventors: Alokik Bhasin, Boston, MA (US); Adam Block, Boston, MA (US); Huawei Gu, Boston, MA (US); Andrew Klein, Boston, MA (US); Daniel Lim, Boston, MA (US); Weikang Song, Boston, MA (US); Xiaoyi Zhang, Boston, MA (US); Zhiyu Zhang, Boston, MA (US)

(21) Appl. No.: 18/679,012

(22) Filed: May 30, 2024

(51) Int. Cl. G06Q 20/40; G06Q 20/38

(52) U.S. Cl. CPC G06Q 20/401; G06Q 20/389

(57) ABSTRACT

Implementations are directed to receiving, by a trusted signing service that is executed in an off-chain network, a user operation, signing, by the trusted signing service, the user operation to provide a signed user operation, receiving, by a paymaster that is executed in a chain network, a call to verify, the call including at least a signature of the signed user operation, and in response to determining that the signature of the signed user operation is valid, providing, by the paymaster and to an entrypoint that is executed in the chain network, a response to the call indicating that the paymaster is verified, the user operation being executed in the chain network at least partially in response to determining that the signature of the signed user operation is valid.

### TECHNICAL FIELD

This specification relates generally to use of native cryptocurrencies in cryptocurrency networks and more particularly to a trusted signing service and sponsored paymaster to provide native cryptocurrency for transaction fees in chain networks.

### BACKGROUND

The development of distributed ledger technology has enabled a multitude of digital transactions not available in the pre-Internet world. For example, distributed ledger technology enables users to hold digital assets as stores of value and mediums of exchange with immutability and traceability. In general, a digital asset can be described as a virtual store of value that leverages a distributed ledger to store, record, and validate transactions. An example digital asset includes cryptocurrencies. Distributed ledgers can be referred to as blockchains or chains.

Each chain network typically maintains a native cryptocurrency, which is used to facilitate transactions in the chain network. For example, the native cryptocurrency is used to account for transaction fees in the chain network. However, native cryptocurrencies are volatile and behave more like a speculative asset rather than a first-class currency. That is, the volatility of native cryptocurrencies makes them a non-reliable store of value. As a result, users have to constantly re-evaluate the cost of transactions with regard the value of the native cryptocurrency with respect to an underlying fiat currency (e.g., United States Dollar (USD)). This creates overhead (in terms of time and consumption of technical resources) for each transaction.

Further, users interact with multiple chain networks, each chain network having its own native cryptocurrency. For example, a user can use a first cryptocurrency of a first chain network to account for transaction fees for a transaction in a second chain network. In traditional approaches, the first cryptocurrency has to be converted to a second cryptocurrency (a cryptocurrency that is native to the second chain network). This presents multiple technical issues. For example, conversion of cryptocurrencies itself consumes technical resources (processors, memory, bandwidth). Further, from a user perspective, the user has to initiate conversion transactions, which not only diminishes user experience, but also consumes technical resources on user-side computing devices.

### SUMMARY

This specification describes systems, methods, devices, and other techniques relating to native cryptocurrencies in cryptocurrency networks. More particularly, implementations of the present disclosure are directed a trusted signing service and sponsored paymaster to provide native cryptocurrency for transaction fees in a chain network.

In general, innovative aspects of the subject matter described in this specification can include actions of receiving, by a trusted signing service that is executed in an off-chain network, a user operation, signing, by the trusted signing service, the user operation to provide a signed user operation, receiving, by a paymaster that is executed in a chain network, a call to verify, the call including at least a signature of the signed user operation, and in response to determining that the signature of the signed user operation is valid, providing, by the paymaster and to an entrypoint that is executed in the chain network, a response to the call indicating that the paymaster is verified, the user operation being executed in the chain network at least partially in response to determining that the signature of the signed user operation is valid. Other implementations of this aspect include corresponding systems, apparatus, and computer programs, configured to perform the actions of the methods, encoded on computer storage devices.

These and other implementations can each optionally include one or more of the following features: signing the user operation includes calling a key management service that provides the signature; the signature is generated using a portion of the user operation; actions further include identifying, by the trusted signing service, a policy that is applicable to the user operation at least partially using an entity identifier of an entity that is sponsoring transaction fees for execution of the user operation, signing of the user operation to provide the signed user operation being performed in response to determining that the user operation conforms to the policy; the policy provides one or more of a maximum transaction fee, a maximum total of transaction fees for a period, and a maximum number of users operations to be sponsored for the period; actions further include determining an amount of cryptocurrency owed by an entity for transaction fees including a transaction fee for execution of the user operation, and transmitting a request for the amount of cryptocurrency to the entity; and the user operation is received by the trusted signing service from a programmable wallet that is executed on-chain.

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example architecture in accordance with implementations of the present disclosure.

FIG. 2 is an example architecture in accordance with implementations of the present disclosure.

FIG. 3 is an example signal flow diagram in accordance with implementations of the present disclosure.

FIG. 4 is an example process that can be executed in accordance with implementations of the present disclosure.

Like reference numbers and designations in the various drawings indicate like elements.

### DETAILED DESCRIPTION

The technology of this patent application is directed to native cryptocurrencies in cryptocurrency networks. More particularly, implementations of the present disclosure are directed a trusted signing service and sponsored paymaster to provide native cryptocurrency for transaction fees in a chain network.

In some implementations, actions include receiving, by a trusted signing service that is executed in an off-chain network, a user operation, signing, by the trusted signing service, the user operation to provide a signed user operation, receiving, by a paymaster that is executed in a chain network, a call to verify, the call including at least a signature of the signed user operation, and in response to determining that the signature of the signed user operation is valid, providing, by the paymaster and to an entrypoint that is executed in the chain network, a response to the call indicating that the paymaster is verified, the user operation being executed in the chain network at least partially in response to determining that the signature of the signed user operation is valid.

To provide context for the subject matter of the present disclosure, and as introduced above, users can hold digital assets as stores of value and mediums of exchange. In general, a digital asset can be described as a virtual store of value that leverages a distributed ledger (e.g., blockchain) to store, record and validate transactions. A distributed ledger can be described as a decentralized database that immutably stores transactions across a peer-to-peer network. Distributed ledgers can be referred to as blockchains, or chains that are maintained in a chain network (e.g., a network of peer-to-peer nodes). Example digital assets can include, without limitation, cryptocurrencies (e.g., stablecoins), non-fungible tokens (NFTs), security tokens, and the like. For purposes of non-limiting illustration, implementations of the present disclosure are described in further detail herein with reference to example cryptocurrencies. It is contemplated, however, that implementations of the present disclosure can be realized using any appropriate digital assets.

In some examples, a cryptocurrency can be described as a digital currency that uses cryptography to secure transactions that are recorded in a distributed ledger (e.g., blockchain). In some examples, a stablecoin can be described as a cryptocurrency having a value that is tied (pegged) to the value of a real-world, non-digital asset, such as a fiat currency, a commodity, or a financial instrument. Stablecoins are absent the volatility of other cryptocurrencies and, as such, are a useful medium of exchange. Example stablecoins include, without limitation, USD Coin (USDC™).

In general, users hold digital assets on a chain and can manage digital assets using externally owned accounts (EOAs). An EOA is an account that is associated with a public key and a private key pair. A digital wallet can be described as a software application that enables users to access and transact digital assets on chains through one or more EOAs. A digital wallet executes off-chain and stores private keys of each of the one or more EOAs. An EOA can be used to initiate a transaction that is executed using a smart contract account (SCA). The SCA is maintained on-chain and executes transactions triggered by user operations (userOps).

Implementations of the present disclosure are described in further detail herein with reference to example peer-to-peer networks (also referred to herein as chain networks), each maintaining a respective chain. The example peer-to-peer networks can each be described as an Ethereum-compatible network. Ethereum can be described as a decentralized computing infrastructure that executes a virtual machine, referred to as the Ethereum virtual machine (EVM), to execute transactions on a chain. The EVM can be described as a global singleton and operates as a single-instance computer, globally across nodes of the peer-to-peer network. That is, each node in the network executes a local copy of the EVM to execute transactions on the chain. The chain of the peer-to-peer network records the changing state of the EVM as transactions are processed. While Ethereum is referenced herein for purposes of illustration, it is contemplated that implementations of the present disclosure can be realized using any appropriate peer-to-peer network (e.g., networks that provide on-chain computing; EVM-compatible chains). Example peer-to-peer networks can include, without limitation, Arbitrum, Avalanche, Base, and Tron, among several others.

Executing transactions in peer-to-peer networks requires the consumption of technical resources (e.g., processing, memory). In other words, computational effort is expended. In the context of Ethereum, gas refers to a unit of measure of the amount of computational effort required to execute specific operations. To pay for a transaction, a transaction fee, referred to as a gas fee in Ethereum, is determined as the amount of gas used to perform operations of the transaction, multiplied by a cost per unit gas. The transaction fee is paid regardless of whether a transaction succeeds or fails. In Ethereum, transaction fees (gas fees) are paid in Ethereum's native cryptocurrency, which is referred to as ether (ETH). It can be noted that chain networks require transaction fees on transactions to incentivize block builders (which can be referred to as miners) and to protect chain networks against denial of service (DOS) attacks. The mechanics for transaction fees have traditionally been built into the consensus process of the chain network itself, often requiring gas fees to be paid in tokens of native cryptocurrency and sourced by the address that initiated the transaction.

However, in using digital assets as a means of exchange, users may have digital assets on one chain that they would like to use on another chain. For example, a user can seek to execute a transaction on a destination chain, but pay transaction fees for the transaction on the destination chain using a digital asset that is maintained on a source chain. However, each chain network maintains a native cryptocurrency, which is used to facilitate transactions in that chain network. Users interact with multiple chain networks, each chain network having its own native cryptocurrency.

To highlight this, a non-limiting illustrative example can be considered, which includes Alice transferring a digital asset (e.g., a NFT) to Bob in a chain network. The transfer requires computational effort (in Ethereum, gas) to execute the transaction in the chain network, which requires a transaction fee (in Ethereum, gas fee that is paid in ETH). In this example, Alice has an amount of cryptocurrency (e.g., stablecoin) in a SCA in the chain network that Alice would like to use to pay the transaction fee. However, Alice's cryptocurrency on the source chain is non-native with respect to the chain network.

Such scenarios present multiple issues. For example, in a traditional approach, multiple transactions would need to be executed to facilitate the transaction on the chain network. With continued reference to the non-limiting example above, Alice would have to obtain a sufficient amount of native cryptocurrency to cover the transaction fees. This, however, can itself require multiple transactions and commensurate expenditure of technical resources, not to mention additional transaction fees. Further, and in some instances, Alice would have to initiate each of the multiple transactions from respective accounts. This not only consumes resources on the device Alice uses (user-side computing devices), but also diminishes user experience (UX) (e.g., navigating between multiple accounts and waiting for one transaction to complete before initiating a next transaction).

Accordingly, the experience of sourcing tokens of a native cryptocurrency by the originating wallet (i.e., the address that initiates a transaction) makes it difficult for users to interact on-chain, from the perspective of consumption of technical resources and UX, and limits usability of blockchain applications. Specifically for providers of cryptocurrencies, such as stablecoins, this arises when users of any smart contract developed by the provider (e.g., USDC™) are required to hold tokens of a native cryptocurrency (e.g., ETH) to complete any transactions. This diminishes UX as users have to on-ramp and maintain balances of these native cryptocurrencies, as discussed above. Further, in a multi-chain world, where users transact on multiple, disparate chain networks, this becomes increasingly complex as users have to hold tokens of native cryptocurrencies for every chain they transact on. Further, developers that use programmable wallets seek to create experiences in which they abstract out tokens of native cryptocurrencies completely for their end-users. For example, such developers either want to sponsor transaction fees for users and/or enable users to pay for transaction fees in tokens of a non-native cryptocurrency that the user already holds (e.g., pay USDC™).

In view of the foregoing, implementations of the present disclosure are directed to trusted signing service, provided as an off-chain paymaster gas station, that enables on-chain paymasters to sponsor transaction fees for users in native cryptocurrencies. As described in further detail herein, the trusted signing service, also referred to herein as the paymaster gas station, is provided off-chain, which provides verification of user operations for transactions that are to have transaction fees accounted for by a paymaster that is on-chain. For example, a paymaster, which is also referred to herein as a sponsored paymaster, is executed on-chain within a chain network that incurs transaction fees for execution of transactions. The paymaster gas station verifies user operations and, if verified, signs user operations to enable the sponsored paymaster to account for transactions executed in response to the (verified) user operations. In some examples, the paymaster gas station enables developers (e.g., of programmable wallets) to sponsor transaction fees for users, which enables the developer to account for transaction fees on behalf of its users. In this manner, the users are not required to hold any native cryptocurrency before transacting on a chain network that requires transaction fees to be accounted for in the native cryptocurrency.

Implementations of the present disclosure will be described in further detail herein with reference to USDC™ as a non-native cryptocurrency and ETH as a native cryptocurrency from the perspective of an on-chain network. It is contemplated, however, that implementations of the present disclosure can be realized using an appropriate non-native cryptocurrency and/or any appropriate native cryptocurrency.

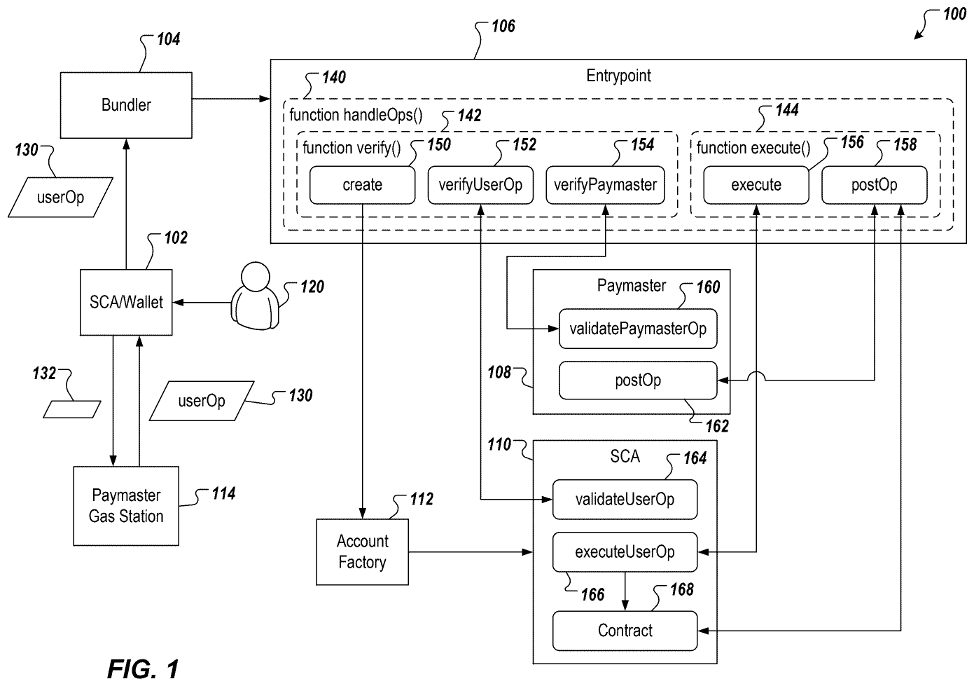

FIG. 1 depicts an example architecture 100 in accordance with implementations of the present disclosure. As described in further detail herein, the example architecture 100 includes components that execute within an off-chain network (e.g., one or more computing devices that are independent of a chain network) and components that execute within an on-chain network (e.g., one or more computing devices that provision nodes of the chain network).

In the example of FIG. 1, the architecture 100 includes a user account 102, a bundler 104, an entrypoint 106, a paymaster 108, a SCA 110, an account factory 112, and a paymaster gas station 114. As described in further detail herein, the paymaster gas station 114 enables the paymaster 108, as a sponsored paymaster, to sponsor transaction fees for users in native cryptocurrencies. In some examples, the paymaster gas station 114 is a trusted signing service that is executed in the off-chain network. In some examples, the entrypoint 106, the paymaster 108, the SCA 110, and the account factory 112 are executed in the on-chain network. Components executed in the on-chain network can be provided as smart contracts. Smart contracts can be described as programs that are executed on-chain and are each provided as a collection of code (functions) and data (state) that resides at a specific address on the chain.

In some examples, the user account 102 is an off-chain program that stores private keys of a user 120, each private key corresponding to an account (e.g., SCA) of the user 120 on a chain maintained by the on-chain network. For example, the user account 102 can be provided as a wallet, such as a programmable wallet that is provisioned by a developer. In general, a programmable wallet can be described as a cryptocurrency wallet that enables a user (e.g., the user 120) to execute smart contracts, automate transactions, and implement custom functionalities to program specific conditions for managing cryptocurrencies.

The bundler 104 listens for user operations, such as a user operation 130, that is to be executed in the on-chain network on behalf of the user 120. While a single bundler 104 is depicted, it is contemplated that multiple bundlers can be provided. The bundler 104 sends bundles of user operations as regular transactions to nodes of the on-chain network. Further, although the example of FIG. 1 depicts the bundler 104 receiving the user operation 130 directly from the user account 102, it is contemplated that the user operation 130 can be received from an alternative (alt) mempool. In some examples, an alt mempool serves as off-chain storage for user operations that are to be executed on the chain of the on-chain network. At a high-level, the alt mempool can be described as a memory pool that holds pending user operations that have not been picked up for execution by the bundler 104. The alt mempool can be described as an alternative to (is different from) so-called canonical memory pools that are used to hold user operations for respective nodes of the on-chain network. Further details of alternative memory pools are provided in Ethereum Request for Comment (ERC) 4337 (ERC-4337) (also referred to as Ethereum Improvement Proposal (EIP) 4337 (EIP-4337)), which is incorporated herein by reference in the entirety for all purposes.

With continued reference to FIG. 1, the entrypoint 106 receives a bundle (of user operations) from the bundler 104, the bundle including the user operation 130. In some examples, a user operation can include creating a user account (e.g., SCA) for a user within the on-chain network. This can be described as onboarding the user to the on-chain network. For example, if the user 120 does not have an account with the on-chain network, a user operation can be executed to trigger the account factory 112 to create the SCA 110 for the user 120.

In accordance with implementations of the present disclosure, the paymaster 108 is a sponsored paymaster that is provided as a smart contract and facilitates payment of transaction fees in the on-chain network on behalf of users. For example, and as described in further detail herein, the paymaster 108 can account for transaction fees in a native (from the perspective of the on-chain network) cryptocurrency (e.g., ETH) of the on-chain network. In some examples, the paymaster 108 is funded with amounts of native cryptocurrency from a sponsor, which can be described as an entity that sponsors expenditures of native cryptocurrency on behalf of users. An example sponsor can include, but is not limited to, a developer of a programmable wallet (e.g., the user account 102 of FIG. 1). In some examples, and as described in further detail herein, the paymaster 108 is funded with amounts of native cryptocurrency, accounts for transactions using the amounts of native cryptocurrency, and periodically invoices the sponsor based on the amounts of native cryptocurrency expended for transactions.

In accordance with implementations of the present disclosure, and as introduced above, the paymaster 108 is deployed to the on-chain network to account for transaction fees on behalf of users (e.g., the user 120) in the native cryptocurrency. In some examples, the paymaster 108 enables the user 120 to be onboarded to the on-chain network (e.g., using the account factory 112 to create the SCA 110 for the user 120) without the user 120 needing to hold native cryptocurrency. In the context of ETH, this can be referred to as ETH-less onboarding.

In further detail, the paymaster 108 is funded with native cryptocurrency from a liquidity source (not depicted in FIG. 1). For example, the paymaster 108 can interact with an exchange to exchange an amount of non-native cryptocurrency (e.g., USDC™) for an equivalent amount of native cryptocurrency (e.g., ETH). In some examples, the paymaster 108 pays for user operations in the native cryptocurrency (e.g., ETH), while charging a fee. In some implementations, the paymaster 108 includes a deposit with the entrypoint 106. The deposit includes an amount of native cryptocurrency of the paymaster 108 held on the entrypoint 106 for payment of transactions. In some implementations, the paymaster 108 includes a stake with the entrypoint 106. The stake includes an amount of native cryptocurrency provided by the paymaster 108 held on the entrypoint 106 for payment of other operations (e.g., accessing storage of the entrypoint 106).

As depicted in FIG. 1, the entrypoint 106 can be configured with various functions and sub-functions. In the example of FIG. 1, the entrypoint 106 is configured with a user operation handling function (handleOps( )) 140 that includes a verify sub-function (verify( )) 142 and an execute sub-function (execute( )) 144. The verify sub-function includes a create function (create) 150, a user operation verification function (verifyUserOp) 152, and a paymaster verification function (verifyPaymaster) 154. The execute sub-function includes an execute function (execute) 156 and a post operation function (postOp) 158. As depicted in FIG. 1, the paymaster 108 includes a validate paymaster operation function (validatePaymasterOp) 160 and a post operation function (postOp) 162. Although not depicted in FIG. 1, other example functions include a deposit function (deposit), a withdraw to function (withdrawTo), a get deposit function (getDeposit), an add stake function (addStake), an unlock stake function (unlockStake), and a withdraw stake function (withdrawStake), each of which is discussed in further detail in EIP-4337. The SCA includes a user validation operation function (validateUserOp) 164, an execute user operation function (executeUserOp) 166, and one or more contract functions 168.

In accordance with implementations of the present disclosure, a user operation, such as the user operation 130, can be sponsored, such that the paymaster 108 accounts for transaction fees incurred by execution of the user operation 130. More particularly, an unsigned user operation 132 is sent to the paymaster gas station 114 (e.g., using an application programming interface (API) call), which executes a set of checks and, if passing the set of checks, signs the user operation 132 to provide the (signed) user operation 130. User operations can be described as data objects that contain details of transactions to be executed on behalf of users in the chain network. The transaction details are provided in a set of fields. In some examples, a user operation, such as the user operation 130, includes a set of fields that includes, but is not limited to a call gas limit (callGasLimit), a verification gas limit (verificationGasLimit), a pre-verification gas amount (preVerificationGas), and paymaster address and data (paymasterAndData). In some examples, fields can also include a payload, a sender, and a nonce.

In further detail, in response to receiving the unsigned user operation 132, the paymaster gas station 114 verifies the request for sponsorship, executes sanction checks, estimates an amount of computational effort (e.g., gas) that would be required to process the user operation (e.g., using a gas estimation service), and applies a signature to provide the user operation 130. In some examples, signing can be executed using a key management service (KMS), described in further detail herein. The user account 102 receives the (signed) user operation 130 from the paymaster gas station 114 and sends the user operation 130 to the bundler 104 (e.g., through an alt mempool). The user operation 130 is subsequently provided to the entrypoint 106.

In some examples, in response to a user operation (e.g., the user operation 130), the paymaster verification function (verifyPaymaster) 154 of the entrypoint 106 calls the validate paymaster operation function (validatePaymasterOp) 160 to check whether the paymaster 108 will process the transaction requested in the user operation (userOp)). For example, the paymaster 108 can determine whether the user operation 130 is signed by the paymaster gas station 114 indicating that the user operation 130 is authenticated for sponsorship of transaction fees by the paymaster 108. If the paymaster 108 is validated, the user operation verification function (verifyUserOp) 152 of the entrypoint 106 calls the user validation operation function (validateUserOp) 164 of the SCA 110 to validate the user operation. For example, the SCA 110 can verify that the user account 102 is the source of the user operation (the user account 102 being authorized for transactions using the SCA 110). If either the paymaster verification or the user operation verification fails, the transaction fails and is not executed.

If both the paymaster verification and the user operation verification succeed, the execute sub-function includes an execute function (execute) 156 of the entrypoint 106 calls the execute user operation function (executeOp( )) 166 of the SCA 110 to execute the transaction within the on-chain network. An example transaction can include, for example and without limitation, transferring a digital asset from the SCA 110 to another SCA within the chain network. In some examples, the one or more contract functions 168 are executed to execute the transaction within the chain network.

After the transaction is complete, the post operation function 158 of the entrypoint 106 calls the post operation function (postOp) 162 of the paymaster 108. In some examples, the entrypoint 106 informs the paymaster 108 (e.g., through the postOp call) of the transaction fee incurred for execution of the transaction. For example, a portion of the transaction fee is paid to the bundler 104 by the entrypoint 106 using the deposit of native cryptocurrency of the paymaster 108 that is stored on the entrypoint 108.

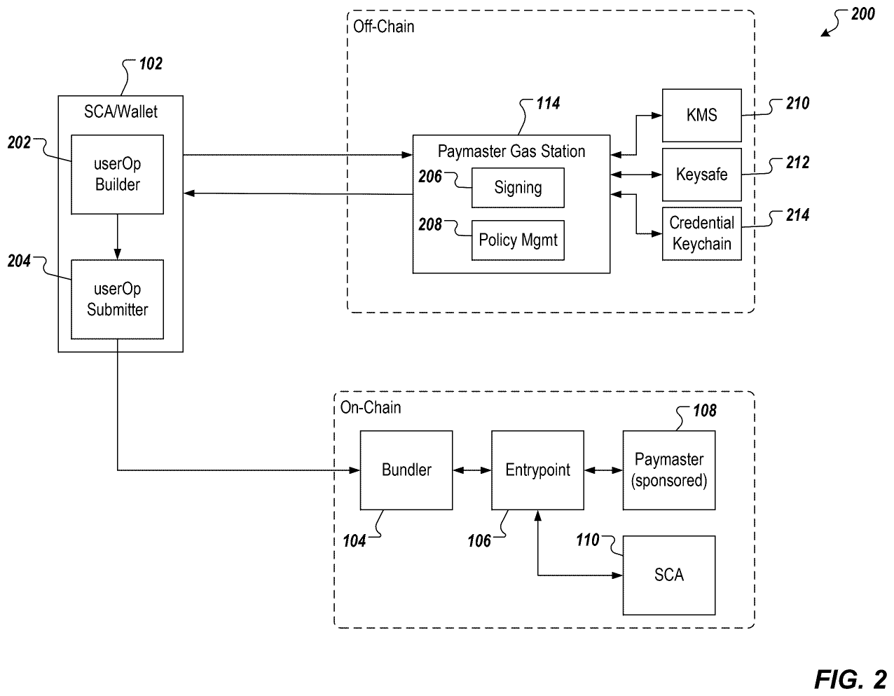

FIG. 2 is another example architecture 200 in accordance with implementations of the present disclosure. The example architecture 200 includes the user account 102, the bundler 104, the entrypoint 106, the paymaster 108, the SCA 110, and the paymaster 114. In the example of FIG. 2, the user account 102 includes a user operation builder 202 and a user operation submitter 204, and the paymaster gas station 114 includes a signing module 206 and a policy management module 208. As depicted in FIG. 2, and as described in further detail herein, the paymaster gas station 114 interacts with a KMS 210, a credential keysafe service 212, and a credential keychain service 214 for signing user operations received from the user account 102.

In some examples, the paymaster gas station 114 can provide external APIs to verify which user operations transaction fees are to be sponsored by the paymaster 108, provide internal APIs to conduct transactions (e.g., stake, withdraw, pause, deposit, resume) of the paymaster 108 (e.g., call the deposit function of the paymaster 108 to deposit an amount of native cryptocurrency to the entrypoint 106), and provide transaction data to support invoicing of the sponsor that is to account for the transaction fees that had been sponsored (expended) by the paymaster 108). Although not depicted in FIG. 2, the paymaster gas station 114 can store one or more tables in a database. Example tables can include, but are not limited to, a policies table, a paymasters table, an entity table, and a terminal operations table, discussed in further detail herein.

In some implementations, the user operation builder 202 of the user account 102 builds a user operation (e.g., in response to input of the user 120). If it is determined that transaction fees for the user operation are to be sponsored, the user account 102 calls the paymaster gas station 114 to sign the user operation (e.g., an API call). In some examples, the call includes an entity identifier (entity ID) that uniquely identifies a sponsor that is to account for the transaction fees for execution of the user operation.

In response to receiving the user operation, the policy management module 208 processes the request to determine whether any policies in a set of policies is to be applied to the user operation and, if so, whether the user operation conforms to the polic-y/-ies. In some examples, a policy, also referred to as a paymaster policy, can be described as a set of rules defined at an entity-level that govern how and when transaction fees are to be sponsored for user operations. Here, entity-level refers to sponsors (e.g., developers of programmable wallets) that are agreeing to sponsor transaction fees for users and under what conditions. In some examples, a policy can limit an amount of transaction fees that are to be sponsored per user operation. In some examples, a policy can limit a total amount of transaction fees that can be sponsored for a period (e.g., hourly, daily, weekly, monthly). In some examples, a policy can limit a frequency of transaction fee sponsorship for a period (e.g., hourly, daily, weekly, monthly). In some examples, a UI can be provided in a development console that enables developers to create and configure policies that can be recorded in the policies table. In some examples, each policy is associated with an entity (sponsor), a chain network (indicating the particular chain network that the policy is applicable to, and a target (e.g., types of user accounts that are to be sponsored for transaction fees).

In some examples, each policy can be provided as a data object that includes a set of fields and values. Example fields can include, but are not limited to, policy ID (uniquely identifying the policy), entity ID, paymaster ID (uniquely identifying the paymaster that is to sponsor transaction fees), chain network (name of chain network that will execute the user operation), status (e.g., active, suspended), maximum daily spend, maximum spend per transaction, and maximum transaction per day.

In some implementations, the policy management module 208 uses information provided with the user operation in the call from the user account to determine and apply policies. For example, the information can include the entity ID, a chain ID, and a target ID, which can be used to query the policy table to determine whether any policy is applicable to the user operation. For example, a policy can be applicable if it is associated with the entity ID and the target ID associated with the user operation. In some examples, it can be determined whether the policy is active or suspended. If the policy is suspended, the paymaster gas station 114 can return an error code to the user account 102. If the policy is active, the paymaster gas station 114 can determine whether the user operation conforms to the policy (e.g., are the estimated transaction fees less than a limit defined in the policy). If the user operation does not conform to the policy, the paymaster gas station 114 can return an error code to the user account 102. If the user operation conforms to the policy, the paymaster gas station 114 can sign the user operation and return the (signed) user operation (e.g., the user operation 130 of FIG. 1) to the user account 102.

Accordingly, if the user operation conforms to any applicable policies and any applicable limits are not exceeded, the paymaster gas station 114 signs the user operation to indicate that the user operation is sponsored for payment of transaction fees. To achieve this, the paymaster gas station 114 applies a signature (cryptographic signature) to the user operation. In some examples, signing is done using the paymasterAndData field of the user operation received from the user account 102 (e.g., the (unsigned) user operation 132). More particularly, the signing module 206 generates a signature using KMS signing in conjunction with the KMS 210. In some examples, the signature is a cryptographic signature that is generated using a private key and is signed over a hash of the user operation. In some examples, the paymasterAndData field of a signed user operation is provided as:

* paymasterAndData[:20] : address (of paymaster contract)
* paymasterAndData[20:84] : abi.encode(validUntil, validAfter)
* paymasterAndData[84:] : signature (over partial UserOp)

### Listing 1: Example paymasterAndData Field of Signed User Operation

In the example of Listing 1, address is the address of the paymaster 108 within the chain network and signature is the signature of the paymaster gas station 114 (over at least a portion of the user operation). In some examples, the paymaster gas station 114 stores the raw user operation (e.g., a partial user operation+signature) and other relevant information into the database (e.g., the paymasters table).

In further detail, to generate the signature, the paymaster gas station 114 calls the credential keysafe service 212 and the keychain credential service 214 to create a sign message activity record that is used to call the KMS 210. In response, the KMS 210 generates the signature, which is returned to the paymaster gas station 114 as the signature of the paymaster gas station 114. In some examples, the signature is generated based on an address within the on-chain network that is assigned to the KMS 210. In some examples, the address is generated by deriving a public key from a private key that is generated for the KMS 210 (e.g., using secp256k1 ECC), hashing the public key (e.g., using keccak-256 hash function), and taking the last Z bytes of the hash (e.g., last 20 bytes) and prefixing that with 0x, for example.

In some examples, the credential keysafe service 212 can be described as a service that can be used to securely store entity secrets for, for example, programmable wallets that are without entity secrets. Here, an entity secret can be described as a 32-byte private key (e.g., a secret password) that is used to secure developer-controlled wallets (e.g., the user account 102). In some examples, the entity secret is used to generate an entity secret ciphertext that can be described as an encryption token that is sent in requests (e.g., API requests for wallet creation, transaction initiation) to ensure actions are secure. In some examples, the credential keychain service 214 can be described as a credential storage service that stores credentials (e.g., private keys) of the paymaster gas station 114 used to generate signatures (cryptographic signatures). The credential keychain service 214 can be used to avoid single-point failure of the KMS 210.

The paymaster 108 can be described as a permissioned paymaster, which means that a signer is authorized to sponsor for the paymaster 108. Here, only transactions that the signer has authorized can be sponsored by the transaction. In some examples, authorization occurs using the content of the paymasterAndData field of the user operation. More particularly, the signer signs over the user operation to produce this data. In some examples, the KMS 210 can be described as a service for securely storing and managing wallet keys. The KMS 210 is where the signer is created and is used to sign user operations for sponsoring transactions. In some examples, the paymaster 108 is configured with the on-chain address of the KMS 210, as a configured address, to enable the paymaster 108 to verify signatures of the KMS 210, as described herein.

After signing the user operation, the paymaster gas station 114 returns the (signed) user operation (e.g., the user operation 130 of FIG. 1) to the user account 102. In some examples, the user operation submitter 204 submits the user operation to the chain network for execution. For example, and as discussed above with reference to FIG. 1, the user operation can be handled by the bundler 104, which provides the user operation to the entrypoint 106. The entrypoint 106 can execute a paymaster verification function (verifyPaymaster) to prompt the paymaster 108 to verify whether it will account to transaction fees for the user operation.

In further detail, the paymaster 108 executes the validate paymaster operation function (validatePaymasterOp) to verify that the signature (provided by the KMS 210) is valid. In some examples, the paymaster 108 verifies the signature using signature verification functionality (e.g., EVM ECrecover), which can be executed to verify that the KMS 210 signed the user operation. In some examples, the signature verification functionality determines a recovered address from the signature of the message. The recovered address is compared to the configured address and, if these are the same, the signature is determined to be valid. If the signature is valid, a success response is returned to the entrypoint 106, and execution of the user operation proceeds as discussed above with reference to FIG. 1. If the signature is not valid, a fail response is returned to the entrypoint 106 and the user operation is canceled.

In some implementations, when a user operation moves to a terminal state, a message is provided to the paymaster gas station 114. In some examples, terminal states can include completed (e.g., user operation was successfully executed in the chain network) and failed (e.g., user operation failed in the chain network). For example, and without limitation, a transaction reconciliation worker (e.g., provided as a programmable wallet), can receive the terminal state of a user operation and can publish a message (e.g., TerminalUserOpMessage) to a topic (e.g., PWTerminalUserOpTopic), the message being added to a queue (e.g., PGSTerminalUserOpQueue). For example, the transaction reconciliation worker can receive state notices from a block-monitor service, which can be provided as a blockchain indexer that indexes transactions and provides notification for transactions reaching terminal state (CONFIRMED, COMPLETED) based on blockchain finality. The paymaster gas station 114 records the user operation in the terminal operations table. In this manner, the terminal operations table can be used to enforce, for example, frequency and/or spending limits on entities (sponsors) by referencing the records for a given period.

In some implementations, an entity (sponsor) transfers funds to a cryptocurrency account that is owned by the entity that provisions the paymaster 108. For example, the paymaster gas station 114 can determine an amount of cryptocurrency to request from the entity (sponsor). For example, the paymaster gas station 114 can query the terminal operations table for user operations that the paymaster 108 paid transaction fees for based on the entity ID. In some examples, the amount of cryptocurrency can be determined in the native cryptocurrency of the chain network. In some examples, the amount of cryptocurrency can be determined in a non-native cryptocurrency (e.g., based on an exchange rate). The paymaster gas station 114 requests the amount of cryptocurrency from the sponsor, which processes the request and transfers the amount of cryptocurrency to the cryptocurrency account.

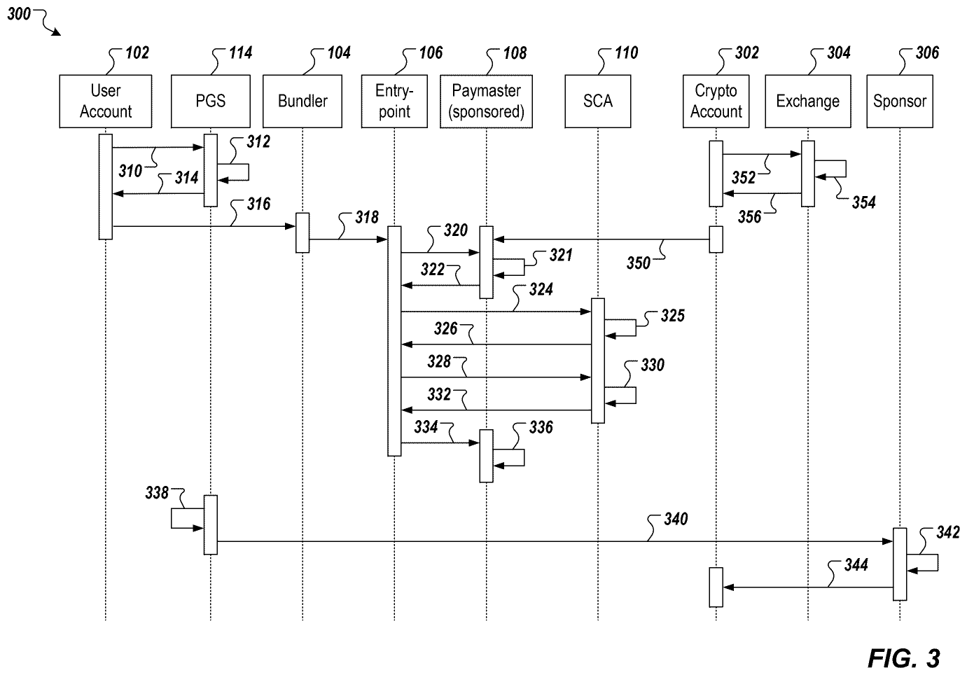

FIG. 3 depicts an example signal flow diagram 300 in accordance with implementations of the present disclosure. The example signal flow diagram 300 of FIG. 3 includes the user account 102, the paymaster gas station 114, the bundler 104, the entrypoint 106, the paymaster 108, the SCA 110, a cryptocurrency account 302, an exchange 304, and a sponsor 306.

The user account 102 calls (310) the paymaster gas station 114 to request that a user operation be signed for sponsorship of transaction fees. The paymaster gas station 114 processes (312) the request. For example, the paymaster gas station 114 can identify a policy that is to be applied to the user operation, can determine whether the user operation conforms to the policy and/or whether any frequency/spending limits have been exceeded, and the like, and can sign the user operation using a KMS (e.g., the KMS 210 of FIG. 2). The paymaster gas station 114 returns (314) a response to the user account 102. For example, the response can include the signed user operation. As another example, the response can include an error (e.g., if the user operation does not conform to a policy).

The user account 102 can submit (316) the (signed) user operation for processing through, for example, the bundler 104. The bundler 104 provides (318) the user operation to the entrypoint 106 (e.g., in a bundle of user operations). The entrypoint 106 calls (320) the paymaster 108 to verify that the paymaster 108 will account for transaction fees for the user operation. The paymaster 108 verifies (321) that the user operation was signed by the paymaster gas station 114 and sends (322) a response to the entrypoint 106. For example, the response can indicate verification by the paymaster 108 (e.g., the signature is verified). As another example, the response can indicate no verification by the paymaster 108 (e.g., the signature was not verified). If the paymaster 108 is verified, the entrypoint 106 calls (324) the SCA 110 to verify the user operation. The SCA 110 verifies (325) the user operation and sends (326) a response to the entrypoint 106. For example, the response can indicate verification by the SCA 110. As another example, the response can indicate no verification by the SCA 110.

If the user operation is verified, the entrypoint 106 can call (328) the SCA 110 to execute the user operation. The SCA 110 executes (330) the user operation using, for example, one or more contract functions. An example user operation can include, without limitation, a transaction to transfer a digital asset from the SCA 110 to another SCA. After completion of the user operation, the SCA 110 informs (332) the entrypoint 106. The entrypoint 106 calls (334) the paymaster 334 to execute (336) post operation functionality. For example, the entrypoint 106 informs the paymaster 106 of the transaction fee incurred for execution of the user operation.

The paymaster gas station 114 can determine (338) an amount of cryptocurrency to request from the sponsor 306. For example, the paymaster gas station 114 can query the terminal operations table for user operations that the paymaster 108 paid transaction fees for based on the entity ID of the sponsor 306. In some examples, the amount of cryptocurrency can be determined in the native cryptocurrency of the chain network. In some examples, the amount of cryptocurrency can be determined in a non-native cryptocurrency (e.g., based on an exchange rate). The paymaster gas station 114 requests (340) the amount of cryptocurrency from the sponsor 306. The sponsor 306 processes (342) the request and transfers (344) the amount of cryptocurrency to the cryptocurrency account 302. In some examples, the cryptocurrency account 302 is owned by the entity that provisions the paymaster gas station 114 and the paymaster 108.

In some examples, the cryptocurrency account 302 can transfer (350) an amount of native cryptocurrency to the paymaster 108. For example, the paymaster can deplete its funds of native cryptocurrency accounting for transaction fees for user operations in the chain network. In some examples, the paymaster 108 can monitor expenditure of the native cryptocurrency and, in response to a balance of the paymaster 108 falling below a threshold amount, the cryptocurrency account 302 transfers native cryptocurrency to the paymaster 108. The paymaster 108 can deposit native cryptocurrency with the entrypoint 106. In some examples, the cryptocurrency account 302 may need to obtain native cryptocurrency (e.g., ETH) using, for example, non-native cryptocurrency (e.g., USDC™). Here, the cryptocurrency account 302 can transfer (352) funds (e.g., in non-native cryptocurrency) to the exchange 304, which exchanges (354) the funds for an equivalent amount of native cryptocurrency. For example, the exchange can use an exchange rate to determine the equivalent amount of native cryptocurrency. The exchange 304 transfers (356) the native cryptocurrency to the cryptocurrency account 302. In some examples, exchange of funds for native cryptocurrency is performed each time a user operation is processed (e.g., terminal stat is complete). In this manner, the impact of fluctuations in the exchange rate can be minimized for the entity that provides the paymaster 108.

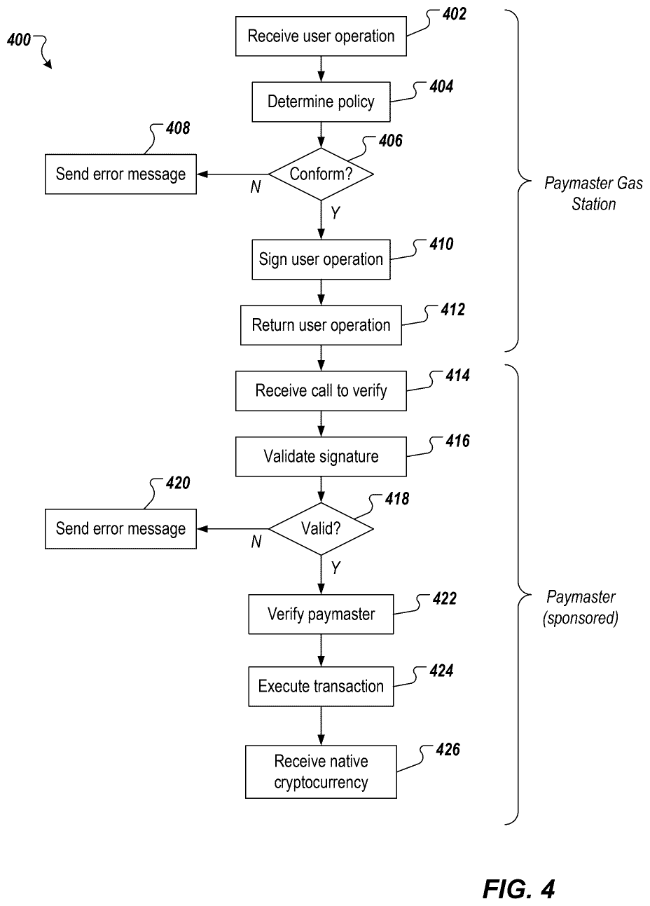

FIG. 4 depicts a flowchart of an example process 400 that can be executed in accordance with implementations of the present disclosure. For convenience, the process 400 will be described as being performed by a system of one or more computers located in one or more locations. Although the flowchart depicts the various tasks of the process 400 occurring in a particular order, certain tasks may in some implementations be performed in parallel or in a different order than what is depicted in the example process 400 of FIG. 4.

A user operation is received (402). For example, and as described herein, the paymaster gas station 114 receives a user operation from the user account 102. A policy is determined (404). For example, and as described herein, the paymaster gas station 114 can use information (e.g., paymaster ID, entity ID) of the user operation to query a policy table and determine a policy that is applicable to the user operation. It is determined whether the user operation conforms to the policy (406). For example, and as described herein, the paymaster gas station 114 can determine whether the user operation conforms to the policy (e.g., an estimated transaction fee does not exceed a maximum transaction fee; a total amount of the entity (sponsor) for a period does not exceed a maximum total amount). If the user operation does not conform to the policy, an error message is sent (408). For example, and as described herein, the paymaster gas station 114 can return an error message to the user account 102.

If the user operation conforms to the policy, the user operation is signed (410). For example, and as described herein, the paymaster gas station 114 calls the KMS 210 to provide a signature for the user operation. The (signed) user operation is returned (412). For example, and as described herein, the paymaster gas station 114 returns the user operation to the user account 102. As also described herein, the user account 102 submits the (signed) user operation to the chain network for execution. For example, and as discussed above with reference to FIG. 1, the user operation can be handled by the bundler 104, which provides the user operation to the entrypoint 106. A call is received to verify the paymaster (414). For example, and as described herein, the entrypoint 106 can execute a paymaster verification function (verifyPaymaster) to call the paymaster 108 to verify whether it will account to transaction fees for the user operation.

A signature of the user operation is validated (416). For example, and as described herein, the paymaster 108 executes the validate paymaster operation function (validatePaymasterOp) to verify that the signature (provided by the KMS 210) is valid. In some examples, the paymaster 108 verifies the signature using signature verification functionality (e.g., EVM ECrecover), which can be executed to verify that the KMS 210 signed the user operation. It is determined whether the signature is valid (418). For example, a result of the signature verification functionality indicates whether the signature is valid. If the signature is not valid, an error message is sent (420). For example, and as described herein, the paymaster 108 can respond to the entrypoint 106 that the paymaster is not verified.

If the signature is valid, the paymaster is verified (422). For example, and as described herein, the paymaster 108 can respond to the entrypoint 106 that the paymaster is verified. As also described in detail herein with reference to FIG. 1, the entrypoint 106 can verify the user operation with the SCA 110. If the paymaster verification and the user operation verification succeed, the transaction is executed (424). For example, the entrypoint 106 calls the SCA 110 to execute the transaction of the user operation within the on-chain network. After the transaction is complete, the post operation function of the paymaster 108 is called by the entrypoint 106, which informs the paymaster 108 (e.g., through the postOp call) of the transaction fee incurred for execution of the transaction. An amount of native cryptocurrency is received (428). For example, and as described herein, after execution of the user operation, native cryptocurrency can be transferred to the paymaster 108 to compensate for the transaction fees expended by the paymaster 108 in handling the user operation. In some examples, the native cryptocurrency is transferred to the paymaster 108 from the cryptocurrency account 302, as discussed with reference to FIG. 3.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for execution of user operations in chain networks, comprising:
receiving, by a trusted signing service that is executed in an off-chain network, a user operation;
signing, by the trusted signing service, the user operation to provide a signed user operation;
receiving, by a paymaster that is executed in a chain network, a call to verify, the call comprising at least a signature of the signed user operation; and
in response to determining that the signature of the signed user operation is valid, providing, by the paymaster and to an entrypoint that is executed in the chain network, a response to the call indicating that the paymaster is verified, the user operation being executed in the chain network at least partially in response to determining that the signature of the signed user operation is valid.

2. The computer-implemented method of claim 1, wherein signing the user operation comprises calling a key management service that provides the signature.

3. The computer-implemented method of claim 1, wherein the signature is generated using a portion of the user operation.

4. The computer-implemented method of claim 1, further comprising identifying, by the trusted signing service, a policy that is applicable to the user operation at least partially using an entity identifier of an entity that is sponsoring transaction fees for execution of the user operation, signing of the user operation to provide the signed user operation being performed in response to determining that the user operation conforms to the policy.

5. The computer-implemented method of claim 4, wherein the policy provides one or more of a maximum transaction fee, a maximum total of transaction fees for a period, and a maximum number of users operations to be sponsored for the period.

6. The computer-implemented method of claim 1, further comprising:
determining an amount of cryptocurrency owed by an entity for transaction fees including a transaction fee for execution of the user operation; and
transmitting a request for the amount of cryptocurrency to the entity.

7. The computer-implemented method of claim 1, wherein the user operation is received by the trusted signing service from a programmable wallet that is executed on-chain.

8. A non-transitory computer-readable storage medium coupled to one or more processors and having instructions stored thereon which, when executed by the one or more processors, cause the one or more processors to perform operations for execution of user operations in chain networks, the operations comprising:
receiving, by a trusted signing service that is executed in an off-chain network, a user operation;
signing, by the trusted signing service, the user operation to provide a signed user operation;
receiving, by a paymaster that is executed in a chain network, a call to verify, the call comprising at least a signature of the signed user operation; and
in response to determining that the signature of the signed user operation is valid, providing, by the paymaster and to an entrypoint that is executed in the chain network, a response to the call indicating that the paymaster is verified, the user operation being executed in the chain network at least partially in response to determining that the signature of the signed user operation is valid.

9. The non-transitory computer-readable storage medium of claim 8, wherein signing the user operation comprises calling a key management service that provides the signature.

10. The non-transitory computer-readable storage medium of claim 8, wherein the signature is generated using a portion of the user operation.

11. The non-transitory computer-readable storage medium of claim 8, wherein operations further comprise identifying, by the trusted signing service, a policy that is applicable to the user operation at least partially using an entity identifier of an entity that is sponsoring transaction fees for execution of the user operation, signing of the user operation to provide the signed user operation being performed in response to determining that the user operation conforms to the policy.

12. The non-transitory computer-readable storage medium of claim 11, wherein the policy provides one or more of a maximum transaction fee, a maximum total of transaction fees for a period, and a maximum number of users operations to be sponsored for the period.

13. The non-transitory computer-readable storage medium of claim 8, wherein operations further comprise:
determining an amount of cryptocurrency owed by an entity for transaction fees including a transaction fee for execution of the user operation; and
transmitting a request for the amount of cryptocurrency to the entity.

14. The non-transitory computer-readable storage medium of claim 8, wherein the user operation is received by the trusted signing service from a programmable wallet that is executed on-chain.

15. A system, comprising:
a computing device; and
a computer-readable storage device coupled to the computing device and having instructions stored thereon which, when executed by the computing device, cause the computing device to perform operations for execution of user operations in chain networks, the operations comprising:
receiving, by a trusted signing service that is executed in an off-chain network, a user operation,
signing, by the trusted signing service, the user operation to provide a signed user operation,
receiving, by a paymaster that is executed in a chain network, a call to verify, the call comprising at least a signature of the signed user operation, and
in response to determining that the signature of the signed user operation is valid, providing, by the paymaster and to an entrypoint that is executed in the chain network, a response to the call indicating that the paymaster is verified, the user operation being executed in the chain network at least partially in response to determining that the signature of the signed user operation is valid.

16. The system of claim 15, wherein signing the user operation comprises calling a key management service that provides the signature.

17. The system of claim 15, wherein the signature is generated using a portion of the user operation.

18. The system of claim 15, wherein operations further comprise identifying, by the trusted signing service, a policy that is applicable to the user operation at least partially using an entity identifier of an entity that is sponsoring transaction fees for execution of the user operation, signing of the user operation to provide the signed user operation being performed in response to determining that the user operation conforms to the policy.

19. The system of claim 18, wherein the policy provides one or more of a maximum transaction fee, a maximum total of transaction fees for a period, and a maximum number of users operations to be sponsored for the period.

20. The system of claim 15, wherein operations further comprise:
determining an amount of cryptocurrency owed by an entity for transaction fees including a transaction fee for execution of the user operation; and
transmitting a request for the amount of cryptocurrency to the entity.

21. The system of claim 15, wherein the user operation is received by the trusted signing service from a programmable wallet that is executed on-chain.
